(19) United States
(12) Patent Application Publication
(10) Pub. No.: US 2021/0013519 A1
(43) Pub. Date: Jan. 14, 2021

(54) MEMBRANE ELECTRODE ASSEMBLY WITH SUPPORTED METAL OXIDE

(71) Applicant: BALLARD POWER SYSTEMS INC., Burnaby (CA)

(72) Inventors: Rajesh BASHYAM, Delta (CA); Lida GHASSEMZADEH, Burnaby (CA); Kyoung J. BAI, Cranbrook (CA); Esmaeil Navaei ALVAR, Burnaby (CA); Ping HE, Surrey (CA)

(21) Appl. No.: 16/969,895

(22) PCT Filed: Feb. 13, 2019
(86) PCT No.: PCT/US2019/017890

§ 371 Date: Aug. 13, 2020

Related U.S. Application Data
(60) Provisional application No. 62/630,733, filed on Feb. 14, 2018.

(51) Int. Cl. H01M 4/90; H01M 4/86; H01M 4/92; H01M 8/1004

(52) U.S. Cl. CPC H01M 4/9016; H01M 4/8657; H01M 2008/1095; H01M 8/1004; H01M 4/921

(57) ABSTRACT

A membrane electrode assembly comprises a polymer electrolyte interposed between an anode electrode and a cathode electrode, the anode electrode comprising an anode catalyst layer adjacent at least a portion of a first major surface of the polymer electrolyte, the cathode electrode comprising a cathode catalyst layer adjacent at least a portion of a second major surface of the polymer electrolyte; at least one of the anode and cathode catalyst layers comprising: a first catalyst composition comprising a noble metal; and a second composition comprising an iridium-containing metal oxide supported on a cerium oxide support.

### BACKGROUND OF THE INVENTION

### Field of the Invention

The present invention relates to a membrane electrode assembly with an improved electrode for use in PEM fuel cells, and to catalyst-coated membranes and fuel cells comprising the improved electrode.

### Description of the Related Art

Fuel cell systems are currently being developed for use as power supplies in numerous applications, such as automobiles and stationary power plants. Such systems offer promise of delivering power economically and with environmental and other benefits. To be commercially viable, however, fuel cell systems should exhibit adequate reliability in operation, even when the fuel cells are subjected to conditions outside their preferred operating ranges.

Fuel cells convert reactants, namely, fuel and oxidant, to generate electric power and reaction products. Polymer electrolyte membrane fuel cells (“PEM fuel cell”) employ a membrane electrode assembly (“MEA”), which comprises a solid polymer electrolyte or ion-exchange membrane disposed between the two electrodes, namely a cathode and an anode. A catalyst typically induces the desired electrochemical reactions at the electrodes. Separator plates, or flow field plates for directing the reactants across one surface of each electrode substrate, are disposed on each side of the MEA.

In operation, the output voltage of an individual fuel cell under load is generally below one volt. Therefore, in order to provide greater output voltage, multiple cells are usually stacked together and are connected in series to create a higher voltage fuel cell stack. (End plate assemblies are placed at each end of the stack to hold the stack together and to compress the stack components together. Compressive force effects sealing and provides adequate electrical contact between various stack components.) Fuel cell stacks can then be further connected in series and/or parallel combinations to form larger arrays for delivering higher voltages and/or currents.

In practice, fuel cells need to be robust to varying operating conditions, especially in applications that impose numerous on-off cycles and/or require dynamic, load-following power output, such as automotive applications. For example, fuel cell anode catalysts are also preferably tolerant to cell voltage reversals and carbon monoxide poisoning; carbon-supported catalysts are also preferably resistant to corrosion during start up and shutdown procedures.

PEM fuel cells typically employ noble metal catalysts, and it is well known that such catalysts, particularly platinum, are very sensitive to carbon monoxide poisoning. This is a particular concern for the anode catalyst of fuel cells operating on reformate; but it also a concern for fuel cells operating on hydrogen, as carbon monoxide (CO) is sometimes present in the hydrogen supply as a fuel contaminant. As described by, e.g., Niedrach et al. in Electrochemical Technology, Vol. 5, 1967, p. 318, the use of a bimetallic anode catalyst comprising platinum/ruthenium, rather than monometallic platinum, shows a reduction in the poisoning effect of the CO at typical PEM fuel cell operating temperatures. Hence, Pt—Ru catalysts are typically employed as PEM fuel cell anode catalysts.

Voltage reversal occurs when a fuel cell in a series stack cannot generate sufficient current to keep up with the rest of the cells in the series stack. Several conditions can lead to voltage reversal in a PEM fuel cell, for example, including insufficient oxidant, insufficient fuel, and certain problems with cell components or construction. Reversal generally occurs when one or more cells experience a more extreme level of one of these conditions compared to other cells in the stack. While each of these conditions can result in negative fuel cell voltages, the mechanisms and consequences of such a reversal may differ depending on which condition caused the reversal. Groups of cells within a stack can also undergo voltage reversal and even entire stacks can be driven into voltage reversal by other stacks in an array. Aside from the loss of power associated with one or more cells going into voltage reversal, this situation poses reliability concerns. Undesirable electrochemical reactions may occur, which may detrimentally affect fuel cell components. Component degradation reduces the reliability and performance of the affected fuel cell, and in turn, its associated stack and array.

As described in U.S. Pat. No. 6,936,370, fuel cells can also be made more tolerant to cell reversal by promoting water electrolysis over anode component oxidation at the anode. This can be accomplished by incorporating an additional catalyst composition at the anode to promote the water electrolysis reaction. During reversal, water present in the anode catalyst layer can be electrolyzed and oxidation (corrosion) of anode components, including carbon catalyst supports, if present, can occur. It is preferred to have water electrolysis occur rather than component oxidation. Thus, by incorporating a catalyst composition that promotes the electrolysis of water, more of the current forced through the fuel cell during voltage reversal can be consumed in the electrolysis of water rather than the oxidation of anode components. Among the catalyst compositions disclosed were Pt—Ru alloys, RuO₂ and other metal oxide mixtures and/or solid solutions including Ru. In another reference, U.S. Pat. No. 9,263,748 describes a layer of iridium or an iridium compound, preferably metallic iridium or iridium oxide supported on TiO2, provided on the anode to electrolyze available water and pass the majority of the current during a reversal of the fuel cell, thereby preventing damage to the MEA.

However, ruthenium has been shown to be unstable under certain fuel cell operating conditions. For example, Piela et al. (J. Electrochem. Soc., 151 (12), A2053-A2059 (2004)), describe ruthenium crossover from Pt—Ru black catalyst and redeposition at the Pt cathode catalyst in direct methanol fuel cells (DMFC) and hydrogen/air fuel cells under abnormal conditions, such as cell reversal resulting in very high anode potentials (and under normal DMFC operating conditions). It has also been shown that Pt—Ru catalysts are prone to ruthenium dissolution at higher relative humidity operation and cathode carbon corrosion. For example, P. He et al. (ECS Transactions, 33 (1) 1273-1279 (2010)) found that relative humidity (RH) significantly impacted the degree of ruthenium dissolution and crossover, which subsequently affected the cell performance and CO tolerance. Lower operating RH during testing resulted in less ruthenium contamination on the cathode and lower performance losses. In addition, T. Cheng et al. (Journal of The Electrochemical Society, 157 (5) B714-B718 (2010)) investigate anode catalysts with different elemental compositions to cause various degrees of ruthenium crossover. It was found that after anode accelerated stress test cycles, ruthenium crossover and subsequent deposition on the cathode occurred, which result in significant fuel cell performance loss.

Another known failure mode that decreases lifetime relates to degradation of the ion-exchange membrane by, for example, reaction with reactive species such as hydrogen peroxide formed within the fuel cell environment. U.S. Pat. Nos. 6,335,112, 7,537,857, 8,367,267, 8,137,828, U.S. patent application No. 2003/0008196, U.S. patent application No. 2012/0225367, and Japanese Patent Application No. 2003-123777, all disclose the use of various catalysts for the decomposition of hydrogen peroxide species, such as manganese-based oxides and cerium-based oxides. These catalysts are dispersed in the ion-exchange membrane and/or in the cathode catalyst layer to improve lifetimes of hydrocarbon and fluorocarbon based ion-exchange membranes. However, such additives have a negative effect to performance and are prone to dissolution. For example, Coms et al. (ECS Transactions, 16 (2) 1735-1747 (2008)) found that after 200 hours of open circuit voltage testing, significant changes in the cerium concentration were observed. Most notably, the cerium concentration under the electrode area was reduced by about half as the cerium ion migrated beyond the active area to inactive areas of the membrane outside the electrode area. More recently, Banham et al. (ECS Transactions, 58 (1) 369-380 (2013)) found that increasing the anode relative humidity during accelerated stress test cycling led to significantly higher end of life performance losses which was attributed to increased cerium oxide dissolution. Furthermore, Cheng et al. (Journal of The Electrochemical Society, 160(1) F27-F33 (2013)) found that both manganese and cerium additives had a negative impact on performance, and when subjected to cathode accelerated stress tests, the performance loss was even more severe than without the additives, likely due to the reduced protonic conductivity/concentration in the presence of the manganese and cerium additives.

As a result, there exists a need for membrane electrode assemblies and fuel cells that are more robust to operating conditions that impose numerous on-off cycles and/or require dynamic, load-following power output; are tolerant to cell voltage reversals; are resistant to corrosion during start up and shutdown procedures; and can mitigate membrane degradation with respect to hydrogen peroxide formation in the fuel cell, all while maintaining adequate performance. The present invention addresses this need and provides associated benefits.

### BRIEF SUMMARY OF THE INVENTION

In brief, a membrane electrode assembly comprises a polymer electrolyte interposed between an anode electrode and a cathode electrode, the anode electrode comprising an anode catalyst layer adjacent at least a portion of a first major surface of the polymer electrolyte, the cathode electrode comprising a cathode catalyst layer adjacent at least a portion of a second major surface of the polymer electrolyte; at least one of the anode and cathode catalyst layers comprising: a first catalyst composition comprising a noble metal; and a second composition comprising an iridium-containing metal oxide supported on a cerium oxide support.

These and other aspects of the invention are evident upon reference in the attached drawings and following detailed description.

### BRIEF DESCRIPTION OF THE DRAWINGS

FIG. 1 shows the beginning of life polarizations for each of the Comparative Examples and the Present Example.

FIG. 2 shows the OCV decay behavior for each of the Comparative Examples and the Present Example.

### DETAILED DESCRIPTION

In the following description, certain specific details are set forth in order to provide a thorough understanding of the various embodiments of the invention. However, one skilled in the art will understand that the invention may be practiced without these details. In other instances, well-known structures associated with fuel cells, fuel cell stacks, batteries and fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

In this application, a “corrosion resistant support material” is at least as resistant to oxidative corrosion as Shawinigan acetylene black (Chevron Chemical Company, TX, USA).

An electrochemical fuel cell includes an ion-conducting electrolyte interposed between an anode electrode and a cathode electrode, the anode electrode having an anode catalyst layer adjacent the ion-conducting electrolyte and the cathode electrode having a cathode catalyst layer adjacent the ion-conducting electrolyte. In one embodiment, at least one of the anode and cathode catalyst layers includes an iridium-containing metal oxide supported on a cerium oxide support.

As discussed, cerium oxide-containing additives typically have a negative impact on performance, likely due to reduced proton conductivity and proton concentration. The inventors have surprisingly discovered that by using an iridium-containing metal oxide supported on a cerium oxide support as an additive in the anode or cathode catalyst layers, fuel cell performance was not reduced. It is suspected that the dispersion of the iridium-containing metal oxide was improved when supported on a cerium oxide support, thereby improving catalytic activity and performance. It is also suspected that by nucleating an iridium-containing metal oxide on a cerium oxide support, rather than simply mixing an iridium-containing metal oxide with a cerium oxide, the cerium oxide is stabilized and dissolution of cerium oxide is reduced, thereby reducing performance losses over time.

The loading of the iridium-containing metal oxide supported on a cerium oxide support may range from about 10 wt % to about 90 wt %. In specific embodiments, the loading of the iridium-containing metal oxide supported on a cerium oxide support may range from about 20 wt % to about 60 wt %.

In further embodiments, the iridium-containing metal oxide supported on a cerium oxide support may be treated with a hydrophobic modifier, such as that described in PCT Publication No. PCT/US2017/044591. In some embodiments, the hydrophobic modifier may be a fluoro-phosphonic acid compound, such as, but not limited to, 2-perfluorohexyl ethyl phosphonic acid and (1H,1H,2H,2H-heptadecafluorodec-1-yl) phosphonic acid (or C₁₀H₆F₁₇O₃P). Without being bound by theory, such hydrophobic modifiers may form a thin layer of fluoro-phosphonic acid at the surface of the iridium-containing metal oxide supported on a cerium oxide support that renders it hydrophobic through the self-assembled surface via covalent bonding, without significantly affecting the reaction sites (or surface area).

The iridium-containing metal oxide may be, for example, iridium oxide and iridium ruthenium oxide.

In other embodiments, a niobium oxide-containing support may be used to support the iridium-containing metal oxide.

In some embodiments, the iridium-containing metal oxide supported on a cerium oxide support may be heat-treated at an elevated temperature. Without being bound by theory, the heat treatment stabilizes the iridium-containing metal oxide supported on a cerium oxide support through enhanced oxide-oxide interaction. For example, the iridium-containing metal oxide supported on a cerium oxide support may be heat-treated at a temperature of about 400 degrees Celsius to about 800 degrees Celsius, for example, between about 500 degrees Celsius to about 700 degrees Celsius. The heat-treatment time may range from about 30 minutes to about 4 hours, for example, from about 1 hour to about 2 hours. The first catalyst composition comprises at least one noble metal. The noble metal may comprise Pt or an alloy of Pt. In embodiments where a Pt alloy catalyst is employed, the alloy may include another noble metal, such as gold, ruthenium, iridium,-osmium, palladium, silver; and compounds, alloys, solid solutions, and mixtures thereof. In some embodiments, the first catalyst composition comprises a mixture of a noble metal and non-noble metal, such as cobalt, iron, molybdenum, nickel, tantalum, tin, tungsten; and compounds, alloys, solid solutions, and mixtures thereof. While noble metals are described for the first catalyst composition, it is expected that non-noble metals, such as those described above, can also be used as the first catalyst composition in some applications

The first catalyst composition may either be unsupported or supported in dispersed form on a suitable electrically conducting particulate support. In some embodiments, the support used is itself tolerant to voltage reversal. Thus, it is desirable to consider using supports that are more corrosion resistant.

The corrosion resistant support material may comprise carbon, if desired. High surface area carbons, such as acetylene or furnace blacks, are commonly used as supports for such catalysts. Generally, the corrosion resistance of a carbon support material is related to its graphitic nature: the more graphitic the carbon support, the more corrosion resistant it is. Graphitized carbon BA (TKK, Tokyo, JP) has a similar BET surface area to Shawinigan acetylene carbon and is a suitable carbon support material in some embodiments. In other embodiments suitable carbon support materials may include nitrogen-, boron-, sulfur-, and/or phosphorous-doped carbons, carbon nanofibres, carbon nanotubes, carbon nanohorns, graphenes, and aerogels.

Instead of carbon, carbides or electrically conductive metal oxides may be considered as a suitable high surface area support for the corrosion resistant support material. For instance, tantalum, titanium and niobium oxides may serve as a corrosion resistant support material in some embodiments. In this regard, other valve metal oxides might be considered as well if they have acceptable electronic conductivity when acting as catalyst supports.

In embodiments where the first catalyst composition is supported, the loading of the first catalyst composition on the support material is from about 20 to about 80% by weight, typically about 20 to about 50% by weight. For a noble metal catalyst, a lower catalyst loading on the support is typically preferred in terms of electrochemical surface area per gram of platinum (ECA), but a higher catalyst loading and coverage of the support appears preferable in terms of reducing corrosion of the support and in reducing catalyst loss during fuel cell operation.

The amount of the first catalyst composition that is desirably incorporated will depend on such factors as the fuel cell stack construction and operating conditions (for example, current that may be expected in reversal), cost, desired lifetime, and so on. For example, the catalyst loading of the first catalyst composition may range from about 0.01 mg Pt/cm² on the low end for the anode electrode to about 0.8 mg Pt/cm² on the high end for the cathode electrode. The ionomer content may range from, for example, 10 wt % to 50 wt %.

As previously mentioned, the anode and cathode catalyst layers may be applied to a Gas Diffusion Layer (GDL) to form anode and cathode electrodes, or to a decal transfer sheet which is then decal transferred to a surface of the GDL or solid electrolyte, or applied directly to the surface of the solid electrolyte to form a catalyst-coated membrane (CCM). The electrodes or CCM can then be bonded with other components to form an MEA. Alternatively, the application of the catalyst layer on the desired substrate may occur at the same time the remaining MEA components are bonded together.

The present catalyst layers may be applied according to known methods. For example, the catalyst may be applied as a catalyst ink or slurry, or as a dry mixture. Catalyst inks may be applied using a variety of suitable techniques (e.g., hand and machine methods, including hand brushing, notch bar coating, fluid bearing die coating, wire-wound rod coating, fluid bearing coating, slot-fed knife coating, three-roll coating, screen-printing and decal transfer) to the surface of the solid electrolyte or GDL. Examples of dry deposition methods include electrostatic powder deposition techniques and decal transfer.

### EXAMPLES

To synthesize 1 g of the IrO₂ supported on CeO₂ additive, 0.3 g of CeO₂ powder (Sigma-Aldrich, Canada) is grinded using mortar and pestle and dispersed into 30 mL of deionized water using sonication for 20 minutes (1 sec ON/2 sec off, at 60% amplitude using half inch probe). Next, 1.7 g of H₂IrCl₆.nH₂O (36.5 wt.% Ir, Wako Chemicals, USA) is dissolved into 5 mL of deionized water and added to the CeO₂ dispersion while it is stirring. The resulting suspension is stirred for 15 minutes and later heated to 70° C. After reaching the temperature, 0.1 M NaOH solution has been gradually added to the suspension to bring the pH˜7. The pH of 7 and temperature of 70° C. in the heated suspension has been kept at the same level by adding more 0.1 M NaOH solution for a period of 3 hours. Finally the product cooled down to room temperature and filtered and washed to neutrality with deionized water. The filtered IrO₂/CeO₂ nanoparticles are dried overnight at 80° C. and calcined at about 400° C. and about 500° C. for about one hour.

The additives (CeO₂, IrO₂, and synthesized IrO₂/CeO₂ by the method in the foregoing) were added to a platinum-containing anode catalyst ink with 23 wt % Nafion® ionomer. The anode catalyst ink was coated on a decal transfer sheet and then decaled-transferred to a Nafion® NR211 membrane while a platinum-containing cathode catalyst ink with 23 wt % Nafion® ionomer was directly coated onto the opposite side of the membrane. A carbon fiber paper gas diffusion layer was placed on each side of the catalyst layers to form MEAs. The anode loadings of each of the MEAs are listed in Table 1. The cathode platinum loading was 4 g/m² for all of the MEAs. The active area of each of the MEAs was 45cm².

TABLE 1
Anode catalyst and additive loadings

| | Loading (GSM) | | |
|---|---|---|---|
| | First | Second | Second |
| | composition | composition | composition |
| MEA | (platinum) | (IrO₂) | (CeO₂) |
| Comparative Example #1 | 1 | 0 | 0 |
| (baseline) | | | |
| Comparative Example #2 | 1 | 0 | 0.16 |
| (CeO₂ only) | | | |
| Comparative Example #3 | 1 | 0.44 | 0 |
| (IrO₂ only) | | | |
| Present Example #1 | 1 | 0.315 | 0.16 |
| (IrO₂/CeO₂ heat-treated | | | |
| at 400 degrees Celsius) | | | |
| Present Example #2 | 1 | 0.315 | 0.16 |
| (IrO₂/CeO₂ heat-treated | | | |
| at 500 degrees Celsius) | | | |

The MEAs were then tested in a Ballard Standard Test Cell (STC) test fixture with graphite plates. The fuel cells were first conditioned for 12 hours under the following conditions at 1.3 A/cm²:

TABLE 2
Conditioning parameters

| | |
|---|---|
| Temperature | 75° C. (coolant) |
| Inlet Dew Point | 75° C. (fuel and oxidant) |
| Fuel | 100% hydrogen |
| Oxidant | Air |
| Reactant inlet pressure | 5 psig (fuel and oxidant) |
| Reactant flow | 4.5 (fuel), 9.0 (oxidant) slpm |

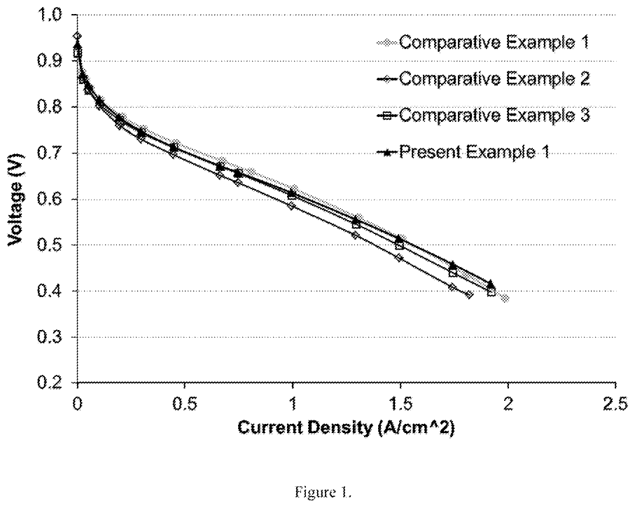

FIG. 1 shows the beginning of life polarizations for each of the examples. It is clear that Comparative Example #2 with cerium oxide only showed the worst performance while the remaining examples showed similar performance. As a result, cerium oxide on its own (Comparative Example #2) had a negative effect on performance. Surprisingly, however, when iridium oxide is supported on cerium oxide (Present Example #1), the negative effect was not observed.

### Cell Reversal Testing

The fuel supply was switched to humidified nitrogen and the cell was supplied with 300 mA/cm² of current through an external power supply under current control mode to drive the cell to reversal. The cell reversal tolerance time was monitored until the cell voltage reached −2.0 V. The results are summarized in Table 3.

TABLE 3
Cell Reversal Tolerance Test Results

| MEA | Cell Reversal Time (mins) |
|---|---|
| Comparative Example #1 (baseline) | 0 |
| Comparative Example #2 (CeO₂ only) | 2 |
| Comparative Example #3 (IrO₂ only) | 48 |
| Present Example #1 (heat-treated | 66 |
| IrO₂/CeO₂ at 400 degrees C.) | |
| Present Example #2 (heat-treated | 70 |
| IrO₂/CeO₂ at 500 degrees C.) | |

It is clear that neither Comparative Example #1 (baseline) nor Comparative Example #2 (cerium oxide only) showed any cell reversal tolerance, while Comparative Example #3 (iridium oxide only) showed cell reversal tolerance, which was to be expected. Surprisingly, Present Examples #1 and #2 (iridium oxide is supported on cerium oxide) showed better cell reversal tolerance than Comparative Example #3 even though the iridium loading of Present Examples #1 and #2 was over 25% lower, such as about 28% lower than that of Comparative Example #3. Without being bound by theory, it is suspected that the dispersion of the iridium-containing metal oxide is improved when supported on a cerium oxide support, thereby improving catalytic activity towards cell reversal tolerance.

### Open Circuit Voltage Testing

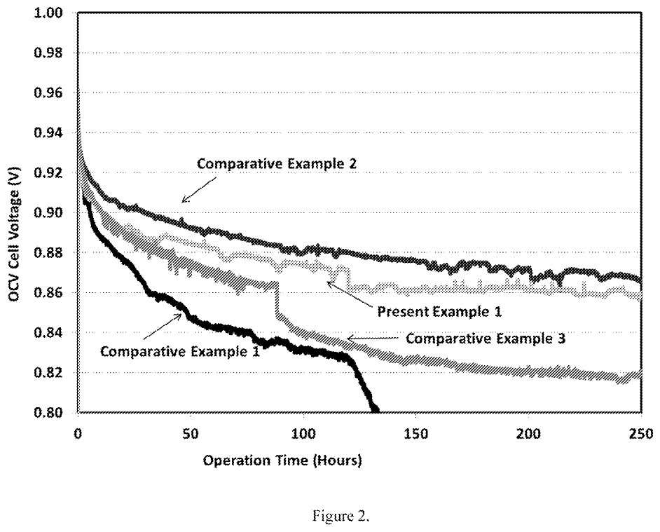

Open Circuit Voltage tests (OCVs) were performed at 85° C. under 56% RH, 20 psig stack back pressure, and at open circuit. Due to time constraints, the tests were terminated after 250 hours of operation. Stack leak rates were determined ex-situ by physically submerging the fuel cell stack in a water bath and measuring the leak rate under 7 psig pressure. Membrane end of life was defined by a stack leak rate higher than 30 ml/min or the cell voltage decay to 0.8V. As shown in FIG. 2, the OCV decay was lowest for Comparative Example #2 (cerium oxide only) and highest for Comparative Example #1 (baseline). It is evident that while Comparative #3 with iridium oxide only had a very high OCV decay but when iridium oxide is supported on cerium oxide (Present Example #1), the OCV decay was still comparable to Comparative Example #2 with cerium oxide only, even though at least some of the surface area of the cerium oxide in Present Example #1 was supporting the iridium oxide. Therefore, the iridium oxide did not significantly affect the hydrogen peroxide mitigation effects of the cerium oxide support.

In summary, Present Example #1, with over 25% lower iridium loading than Comparative Example #3, showed surprising results in its beginning of life performance as well as its cell reversal tolerance, while showing a comparable open circuit voltage decay rate as Comparative Example #2. Present Example #2 also showed a similar cell reversal tolerance as Present Example #1.

While the iridium-containing metal oxide supported on a cerium oxide support has been described for the anode electrode in the preceding description, it is contemplated that such treated metal oxides may, additionally or alternatively, be used on the cathode electrode. Without being bound by theory, such treated metal oxides are beneficial for improved durability by mitigating carbon corrosion at high cathode potentials by acting as a water electrolysis catalyst.

Furthermore, without being bound by theory, it is believed that a ruthenium-containing metal oxide, such as ruthenium oxide, supported on cerium oxide may also show unexpected results with respect to MEA lifetime.

While the present electrodes have been described for use in PEM fuel cells, it is anticipated that they may be useful in other fuel cells having an operating temperature below about 250° C. They are particularly suited for acid electrolyte fuel cells, including phosphoric acid, PEM and liquid feed fuel cells. In addition, such catalysts may also be useful for water electrolysis applications.

All of the above U.S. patents, U.S. patent application publications, U.S. patent applications, foreign patents, foreign patent applications and non-patent publications referred to in this specification and/or listed in the Application Data Sheet, including, but not limited to U.S. Provisional Patent Application No. 62/630,733 filed Feb. 14, 2018, are incorporated herein by reference in their entirety.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. A membrane electrode assembly comprising a polymer electrolyte interposed between an anode electrode and a cathode electrode, the anode electrode comprising an anode catalyst layer adjacent at least a portion of a first major surface of the polymer electrolyte, the cathode electrode comprising a cathode catalyst layer adjacent at least a portion of a second major surface of the polymer electrolyte; at least one of the anode and cathode catalyst layers comprising:
a first catalyst composition comprising a noble metal; and
a second composition comprising an iridium-containing metal oxide supported on a cerium oxide support.

2. The membrane electrode assembly of claim 1, wherein the noble metal of the first catalyst composition is selected from the group consisting of platinum, gold, ruthenium, osmium, palladium, silver; and compounds, alloys, solid solutions, and mixtures thereof.

3. The membrane electrode assembly of claim 1, wherein the noble metal of the first catalyst composition comprises platinum.

4. The membrane electrode assembly of claim 3, wherein first catalyst composition comprises a mixture of platinum and a non-noble metal selected from the group consisting of cobalt, iron, molybdenum, nickel, tantalum, tin, tungsten; and compounds, alloys, solid solutions, and mixtures thereof.

5. The membrane electrode assembly of claim 1, wherein the second composition is treated with a fluoro-phosphonic acid compound.

6. The membrane electrode assembly of claim 1, wherein the iridium-containing metal oxide is iridium oxide or iridium ruthenium oxide.

7. The membrane electrode assembly of claim 1, wherein the first catalyst composition is in a first discrete layer and the second composition is in a second discrete layer in the at least one of the anode and cathode catalyst layers.

8. The membrane electrode assembly of claim 1, wherein the iridium-containing metal oxide supported on the cerium oxide support is heat-treated at a temperature in the range of 400 degrees Celsius and 800 degrees Celsius.

9. The membrane electrode assembly of claim 8, wherein iridium-containing metal oxide supported on the cerium oxide support is heat-treated at a heat-treatment time in the range of 30 minutes and 4 hours.

10. A membrane electrode assembly, comprising:
a polymer electrolyte;
an anode electrode and a cathode electrode with the polymer electrolyte interposed between, the anode electrode comprising an anode catalyst layer adjacent at least a portion of a first major surface of the polymer electrolyte, the cathode electrode comprising a cathode catalyst layer adjacent at least a portion of a second major surface of the polymer electrolyte, at least one of the anode and cathode catalyst layers comprising:
a anode catalyst composition comprising a noble metal; and
a cathode catalyst composition comprising an iridium-containing metal oxide supported on a cerium oxide support.

11. The membrane electrode assembly of claim 10, wherein the iridium-containing metal oxide supported on the cerium oxide support is a water electrolysis catalyst.

12. A membrane electrode assembly comprising:
an anode electrode;
a cathode electrodes;
a polymer electrolyte interposed between the anode electrode and the cathode electrode, the anode electrode comprising an anode catalyst layer adjacent at least a portion of a first major surface of the polymer electrolyte, the cathode electrode comprising a cathode catalyst layer adjacent at least a portion of a second major surface of the polymer electrolyte, at least one of the anode and cathode catalyst layers comprising:
a anode composition comprising an iridium-containing metal oxide supported on a cerium oxide support; and
a cathode catalyst composition comprising a noble metal.

13. The membrane electrode assembly of claim 12, the iridium-containing metal oxide supported on the cerium oxide support improves cell reversal tolerance.
